(19) United States
(12) Patent Application Publication
(10) Pub. No.: US 2026/0181505 A1
(43) Pub. Date: Jun. 25, 2026

(54) METHODS, APPARATUSES AND SYSTEMS FOR FAST HANDOVER

(71) Applicant: Nokia Solutions and Networks Oy, Espoo (FI)

(72) Inventors: Halit Murat GÜRSU, München (DE); Guillaume DECARREAU, Munich (DE); Ahmad AWADA, Munich (DE); Subramanya CHANDRASHEKAR, Bangalore (IN); Rakash SIVASIVA GANESAN, Aschaffenburg (DE)

(21) Appl. No.: 19/125,662

(22) PCT Filed: Oct. 30, 2023
(86) PCT No.: PCT/EP2023/080176

§ 371 Date: Apr. 29, 2025

(30) Foreign Application Priority Data
Nov. 2, 2022 (IN) 202241062523

(51) Int. Cl. H04W 36/22; H04W 36/08

(52) U.S. Cl. CPC H04W 36/22; H04W 36/08

(57) ABSTRACT

Described herein is a source network node configured for supporting an inter-node handover procedure involving at least one target network node and a user equipment (UE) served by the source network node, the source network node comprising: at least one processor; and at least one memory storing instructions that, when executed by the at least one processor, cause the source network node at least to: obtain, from the target network node, a baseline radio resource control (RRC) configuration comprising configuration information usable by the UE to be handed over and connected to the target network node and information indicative of at least one criterion for executing the inter-node handover procedure; determine whether to execute the inter-node handover procedure based on the criterion; and based on determining that the criterion is met: generate a handover command message based on the baseline RRC configuration; and transmit, to the UE, the handover command message for enabling the UE to be connected to the target network node.

### TECHNOLOGY

The present disclosure relates to mobility, in particular to methods, apparatuses and systems for supporting fast handover procedures.

### BACKGROUND

Any discussion of the background art throughout the specification should in no way be considered as an admission that such art is widely known or forms part of common general knowledge in the field.

Broadly speaking, in an inter-node (e.g., inter-eNB, inter-gNB, or the like) procedure, a user equipment (UE) may be configured to report measurements of the neighbouring cell(s), for example on an event basis. Once the event condition holds, the UE may be configured to send a measurement report indicating relevant measurements for a target cell (e.g., controlled by a target node, such as an eNB or a gNB). The source node (e.g., the source eNB or gNB) may then decide to initiate a handover (HO) procedure (e.g., based on conditions like coverage, load, etc.) and send a handover request message with the current UE configuration that UE uses at the source node towards the target node controlling the target cell. In some possible cases where there is no Xn interface between two nodes, the target node may be accessed over AMF, which is generally called a next generation application protocol (NGAP) handover. The target node may be configured to perform admission control, for example to reject or accept the handover request and to provide initial access resources for the UE. The configuration that the target node provides may include, merely as some possible examples, a cell radio network temporary identifier (C-RNTI), a contention-free random access (CFRA) preamble, a data radio bearer (DRB) configuration, quality of service (QoS) flow to DRB mapping, UE capability related features enabled by the target node, or the like. The source node may then be configured to send a handover command message that has the UE configuration for the target cell towards the UE. Subsequently, the UE may be configured to obtain downlink (DL) and uplink (UL) synchronization with the target node and thereafter complete the handover procedure.

However, a possible issue with the message sequence flow of the (conventional) handover procedure is that the handover preparation would typically take time and multiple signalling to request the resource reservation at the target node and correspondingly receive the acknowledgment (ACK) with the target cell configuration, thereby causing delay (or even leading to failure) in the overall handover procedure. The delay may vary depending on the deployment (e.g., NGAP handover or Xn handover) or the architecture (e.g., disaggregated or monolithic structure), but, in some possible cases, delays up to 60 ms may be expected in a disaggregated scenario with NGAP handover. Such delay may in turn increase the likelihood of possible handover failure (HOF) and/or radio link failure (RLF).

Thus, there is a need to propose new mechanisms/techniques for use in supporting an enhanced and fast inter-node handover procedure in order to address some or all of the above-illustrated issues, particularly in an efficient, flexible yet reliable manner.

### SUMMARY

In accordance with an aspect of the present disclosure, there is provided source network node configured for supporting an inter-node handover procedure involving at least one target network node and a user equipment (UE) served by the source network node, the source network node comprising:
at least one processor; and
at least one memory storing instructions that, when executed by the at least one processor, cause the source network node at least to:
obtain, from the target network node, a baseline radio resource control (RRC) configuration comprising configuration information usable by the UE to be handed over and connected to the target network node and information indicative of at least one criterion for executing the inter-node handover procedure;
determine whether to execute the inter-node handover procedure based on the at least one criterion; and
based on determining that the at least one criterion is met:
   generate a handover command message based on the baseline RRC configuration; and
   transmit, to the UE, the handover command message for enabling the UE to be handed over and connected to the target network node.

In some examples, the information indicative of at least one criterion comprises information indicative of a load criterion of the target network node; and
the source network node is caused to:
   obtain load information of the target network node; and
   determine whether to execute the inter-node handover procedure based on whether a load of the target network node indicated by the load information meets the load criterion.

In some examples, the load information comprises information, with respect to the target network node, indicative of at least one of: a number of RRC connections, a number of active UEs, a number of physical resource blocks (PRBs) in use, or a transport network load (TNL) capacity.

In some examples, the information indicative of at least one criterion comprises information indicative of a radio configuration supported or not supported by the target network node.

In some examples, the baseline RRC configuration comprises a baseline low layer configuration for layer 1 (L1) and/or layer 2 (L2) and a baseline high layer configuration for layer 3 (L3) and/or above with respect to the target network node that are usable by the UE in order to connect to the target network node; and
the source network node is caused to generate the handover command message to include the baseline low layer configuration and the baseline high layer configuration.

In some examples, the baseline RRC configuration comprises at least one of: a pool of at least one random access preamble or a pool of at least one cell radio network temporary identifiers (C-RNTI) that are usable for the inter-node handover procedure in order to connect to the target network node and for identifying the UE by the target network node; and
the source network node being caused to generate the handover command message comprises:
   determining a random access preamble and/or a C-RNTI for the UE from the respective pool; and
   generating the handover command message to include the determined random access preamble and/or C-RNTI.

In some examples, the source network node is further caused to:
transmit, to the target network node, a first message comprising information indicative of the determined random access preamble and/or C-RNTI.

In some examples, the first message further comprises information indicative of a user plane configuration of the UE at the source network node.

In some examples, the source network node is further caused to:
receive, after transmitting the first message and from the target network node, a second message comprising information indicating that the determined random access preamble and/or C-RNTI is free to be reused for other UE.

In some examples, the source network node is a next generation radio access network (NG-RAN) node, such as a gNB.

In accordance with another aspect of the present disclosure, there is provided a target network node configured for supporting an inter-node handover procedure involving a source network node and a user equipment (UE) served by the source network node, the target network node comprising:
at least one processor; and
at least one memory storing instructions that, when executed by the at least one processor, cause the target network node at least to:
   generate a baseline radio resource control (RRC) configuration comprising configuration information usable by the UE to be handed over from the source network node to the target network node and information indicative of at least one criterion for executing the inter-node handover procedure; and
   transmit the baseline RRC configuration to the source network node;

In some examples, the information indicative of at least one criterion comprises information indicative of a load criterion of the target network node; and the information indicative of the load criterion includes at least one of: a number of RRC connections, a number of active UEs, a number of physical resource blocks (PRBs) in use, or a transport network load (TNL) capacity.

In some examples, the information indicative of at least one criterion comprises information indicative of a radio configuration supported or not supported by the target network node.

In some examples, the baseline RRC configuration comprises a baseline low layer configuration for layer 1 (L1) and/or layer 2 (L2) and a baseline high layer configuration for layer 3 (L3) and/or above with respect to the target network node that are usable by the UE for connecting to the target network node.

In some examples, the baseline RRC configuration comprises at least one of: a pool of at least one random access preamble or a pool of at least one cell radio network temporary identifier (C-RNTI) that are usable for the inter-node handover procedure in order to connect to the target network node and for identifying the UE by the target network node.

In some examples, the pool of random access preamble and/or the pool of C-RNTI is preconfigured or reserved at the target network node for the inter-node handover procedure.

In some examples, the target network node is further caused to:
receive, from the source network node, a first message comprising information indicative of a random access preamble and/or a C-RNTI determined by the source network node from the respective pool.

In some examples, the first message further comprises information indicative of a user plane configuration of the UE at the source network node.

In some examples, the target network node is further caused to:
transmit, after receiving the first message and to the source network node, a second message comprising information indicating that the random access preamble and/or C-RNTI determined by the source network node is free to be reused for other UE.

In some examples, the source network node is a next generation radio access network (NG-RAN) node, such as a gNB.

In accordance with yet another aspect of the present disclosure, there is provided a method of a source network node for supporting an inter-node handover procedure involving at least one target network node and a user equipment (UE) served by the source network node, the method comprising:
Obtaining, from the target network node, a baseline radio resource control, RRC, configuration comprising configuration information usable by the UE to be handed over and connected to the target network node and information indicative of at least one criterion for executing the inter-node handover procedure;
determining whether to execute the inter-node handover procedure based on the at least one criterion; and
based on determining that the at least one criterion is met:
   generating a handover command message based on the baseline RRC configuration; and
   transmitting, to the UE, the handover command message for enabling the UE to be handed over and connected to the target network node.

In accordance with yet another aspect of the present disclosure, there is provided a method of a target network node for supporting an inter-node handover procedure involving a source network node and a user equipment (UE) served by the source network node, the method comprising:
generating a baseline radio resource control, RRC, configuration comprising configuration information usable by the UE to be handed over from the source network node to the target network node and information indicative of at least one criterion for executing the inter-node handover procedure; and
transmitting the baseline RRC configuration to the source network node.

In accordance with yet another aspect of the present disclosure, there is provided a communication system for supporting an inter-node handover procedure, the communication system comprising:
the source network as disclosed in the present disclosure;
at least one target network as disclosed in the present disclosure; and
a user equipment (UE) served by the source network node.

According to some example embodiments, there is also provided a computer program comprising instructions for causing an apparatus to perform the method as disclosed in the present disclosure.

According to some example embodiments, there is also provided a memory storing computer readable instructions for causing an apparatus to perform the method as disclosed in the present disclosure.

Furthermore, according to some example embodiments, there is provided a source network node configured for supporting an inter-node handover procedure involving at least one target network node and a user equipment (UE) served by the source network node, the source network element comprising respective suitable means configured for performing the respective steps as disclosed in the present disclosure.

Similarly, according to some example embodiments, there is also provided a target network element configured for supporting an inter-node handover procedure involving a source network node and a user equipment (UE) served by the source network node, the target network element comprising respective suitable means configured for performing the respective steps as disclosed in the present disclosure.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses (or systems) according to the above example embodiments and variations thereof, and that respective statements made with regard to the apparatuses (or systems) likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example of a signaling/messaging flowchart of a handover (HO) procedure;

FIG. 2 schematically illustrates an example of a signaling/messaging flowchart of an enhanced fast HO procedure according to some example embodiments of the present disclosure; and

FIG. 3 schematically illustrates an example of an implementation of an apparatus according to some example embodiments of the present disclosure.

### DESCRIPTION OF EXAMPLE EMBODIMENTS

Notably, identical or like reference numbers used in the figures of the present disclosure may, unless indicated otherwise, indicate identical or like elements. Similarly, identical or like messages (as well as the contents comprised therein) used in the figures of the present disclosure may, unless indicated otherwise, indicate identical or like messages (and the contents therein), such that repeated description thereof may be omitted for reasons of conciseness.

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele) communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1

### INCORPORATED BY REFERENCE

Different functional splits between the central and distributed unit are possible, e.g., called options:

Option 1 (1A-like split):
The function split in this option is similar to the 1A architecture in DC. RRC is in the central unit. PDCP, RLC, MAC, physical layer and RF are in the distributed unit.
   Option 2 (3C-like split):
The function split in this option is similar to the 3C architecture in DC. RRC and PDCP are in the central unit. RLC, MAC, physical layer and RF are in the distributed unit.
   Option 3 (intra RLC split):
Low RLC (partial function of RLC), MAC, physical layer and RF are in the distributed unit. PDCP and high RLC (the other partial function of RLC) are in the central unit.
   Option 4 (RLC-MAC split):
MAC, physical layer and RF are in the distributed unit. PDCP and RLC are in the central unit.
Or else, e.g., according to 3GPP TR 38.801 V14.0.0 (2017-03) section 11 incorporated by reference.

A gNB supports different protocol layers, e.g., Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-) layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighbouring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and [0063] functions, which also depend on the actual network type, are known to those skilled in the art and described in corresponding specifications, so that a detailed description thereof may omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g., an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

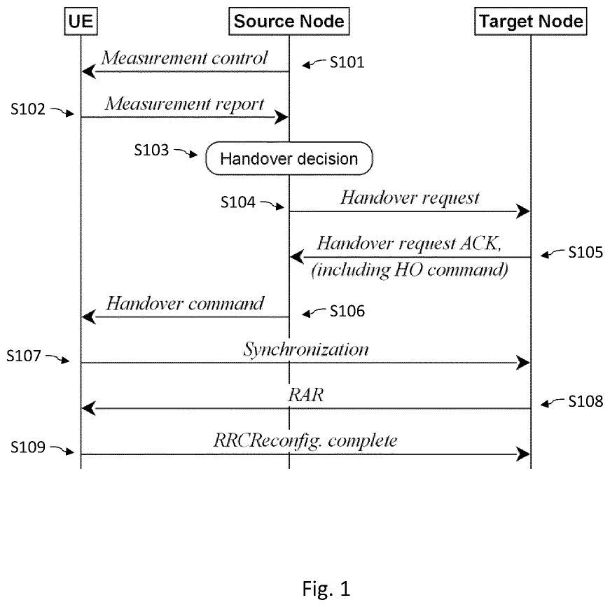

Before going into detail about the example embodiments of the present disclosure, it may be worthwhile to, with reference to the example as shown in FIG. 1, briefly go through some exemplary main steps of a conventional (inter-node) handover procedure involving a UE, a source network node that is currently serving (connected to) the UE, and at least one target network node (though for simplicity reasons, only one target network node is shown in the example of FIG. 1) as summarized below. Notably, as has been illustrated in detail above, the source and target network nodes (or sometimes also referred to as network entity, network component, etc.) may be, depending on various implementations, a suitable next generation radio access network (NG-RAN) node, such as a gNB, or the like, as can be understood and appreciated by the skilled person.

In particular, in such an inter-node (e.g., inter-gNB) handover scenario, the UE may be configured to report measurements of one or more neighbouring cells, for example on an event basis (as exemplified in step S101). Once the event condition holds, the UE may be configured to send a measurement report indicating relevant measurements for a target cell controlled by (one of) the target network node(s) (step S102). Depending on various configurations and requirements, the measurement may be performed on any suitable objects, as can be understood and appreciated by the skilled person. As some possible examples (but not to be understood as a limitation of any kind), based on the measurements performed and reported by the UEs, the source network node may be configured to derived information indicative of at least one of: the number of active (e.g., connected) UEs, the number of RRC connections, the number of physical resource blocks (PRBs) in use, the transport network load (TNL) capacity, or the like.

Subsequently in step S103, the source network node may decide to initiate the handover procedure and send, in step S104, a handover request message with the configuration of the UE that is currently used/applied/configured at the source node towards the target network node controlling the target cell. In some possible cases where there is no Xn interface between these two network nodes, the target network node may be accessed over AMF, which is generally called a next generation application protocol (NGAP) handover.

The target network node may be configured to perform necessary admission control, for example to reject or accept the handover request and to provide initial access resources for the UE in case of acceptance (as exemplified in step S105). The configuration that the target node provides may include (but is certainly not limited thereto) a cell radio network temporary identifier (C-RNTI), a contention-free random access (CFRA) preamble, a data radio bearer (DRB) configuration, quality of service (QoS) flow to DRB mapping, UE capability related features enabled by the target node, or the like.

The source node may then be configured to send, as shown in step S106, a handover command message that comprises the UE configuration for the target cell towards the UE.

Finally, the UE may be configured to obtain DL and UL synchronization with the target network node and thereafter complete the handover procedure, as exemplarily shown in steps S107-S109.

However, as indicated above, a possible issue with the message sequence flow of the (conventional) handover procedure may be that the handover preparation phase would typically take a lot of time and multiple signalling exchanges for example to request the resource reservation at the target node and correspondingly to receive the acknowledgment (ACK) with the target cell configuration, thereby likely causing delay (or even leading to failure) during the overall handover procedure. The delay may vary depending on the deployment (e.g., NGAP handover or Xn handover) or the architecture (e.g., disaggregated or monolithic structure), but, in some possible cases, delays up to 60 ms may be expected for example in a disaggregated scenario with NGAP handover. Such delay may in turn increase the likelihood of possible handover failure (HOF) and/or radio link failure (RLF).

A so-call conditional handover (CHO) procedure that has been introduced in 3rd generation partnership project (3GPP) release 16 may be considered a potential candidate for addressing some of the issues discussed above with respect to the convention handover procedure.

Broadly speaking, in the case of CHO, a UE may be configured with a CHO command containing the target cell configuration and a condition to execute the handover for one or more target cells. The condition may be based on radio measurements. The target cell/node may have prepared a necessary configuration, such as contention free random access (CFRA) resources for the UE. Such configuration may then be communicated to the UE in the CHO command. When UE evaluates the CHO condition and determines that the condition holds for a specific target cell, UE may be configured to apply the CHO command and may use the reserved CFRA resources to initiate the random access procedure to the target cell. As can be understood and appreciated by the skilled person, the UE may be configured with multiple conditions for multiple target cells.

The CHO procedure may be seen to be so designed that the UE can perform/execute the handover without the need of the serving cell to trigger the HO execution (as shown in step S106 of FIG. 1 for a conventional HO) after the measurement report (as shown in steps S101 and S102 of FIG. 1).

Although the CHO may be considered useful in enhancing mobility robustness in some scenarios, it appears to have the following challenges and complexity compared to the conventional handover procedure. Firstly, in CHO use cases, multiple target cells may be prepared where each target cell has to reserve radio resources for some time which can be up to 15 seconds in some possible cases.

Secondly, CHO is generally considered to be an optional feature that may not be implemented by all UEs (e.g., legacy UEs). For these (legacy) UEs, it would be beneficial to have a method that can be applied by the network to improve the mobility robustness of the handover mechanism without impacting the UEs.

Thirdly, each CHO configuration for a prepared target cell may require additional radio signalling, e.g., RRC Reconfiguration or the like, if the preparation is performed at different time instants (which is a very likely scenario).

Fourthly, CHO configurations may need to be updated with changing conditions of the prepared target cells (which may no longer be relevant to be prepared due to for example a degradation in radio link). Such re-configurations would also need further radio and network signalling exchanges.

Finally, a UE may be configured with multiple CHO conditions that it has to continuously evaluate, which would result in increased complexity for the UE.

In view thereof, the present disclosure generally proposes mechanisms/techniques for use in supporting such (enhanced and fast) mobility use cases, e.g., (inter-node) handover or the like, particularly in an efficient, flexible yet reliable manner.

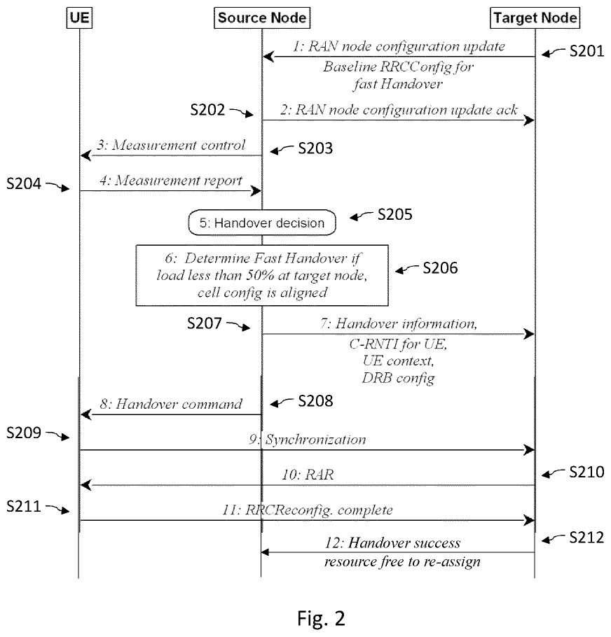

Reference is now made to FIG. 2, which describes the proposed mechanisms/techniques for fast handover in more detail. It is to be noted that, as indicated above, identical or like reference numbers used in the figures of the present disclosure may, unless indicated otherwise, indicate identical or like elements. Similarly, identical or like messages (as well as the contents comprised therein) used in the figures of the present disclosure may, unless indicated otherwise, indicate identical or like messages (and the contents therein), such that repeated description thereof may be omitted for reasons of conciseness.

Particularly, as shown in FIG. 2, in step S201, the target (network) node/element may be configured to generate and share a baseline RRC configuration for the fast HO with the source node without a previous handover request from the source node (e.g., the handover request message as exemplarily shown in step S104 of FIG. 1), for example in any suitable (existing or new) message. Accordingly, as exemplified in step S202, the source node may send a corresponding acknowledgment message back to the target node. In a broad sense, the baseline RRC configuration may be considered to be generated to be specific to a cell pair (or in other words, source and target cell-specific).

Depending on various implementations and/or requirements, the baseline RRC configuration generated by the target node may comprise (but is certainly not limited thereto) for example a baseline low layer configuration (i.e., configuration for the lower layer(s), such as layer 1/L1, e.g., physical (PHY) layer, layer 2/L2, e.g., medium access control (MAC) layer, radio link control (RLC) layer, or packet data convergence protocol (PDCP) layer, or the like). For instance, in some possible examples, the baseline low layer configuration may comprise suitable L1/2 (e.g., cell-specific) configurations, and possibly also configurations related to L1 measurement. In some exemplary cases, it might also be possible to include multiple lower layer configurations (for the same UE, but possibly for different use cases/scenarios) as part of the baseline configuration to the UE. For instance, one possible instance of the multiple low layer configurations may include configuration information (e.g., PDCP and/or RLC configurations) of a radio bearer that is specific to an (e.g., predetermined) network slice ID and/or QoS parameters associated with the bearer. A possible illustrative example for this may be that, in some cases, the target network node (e.g., a target DU) may be configured to provide a lower layer configuration that should be used only for DRBs associated with an ultra-reliable low-latency communication (URLLC) PDU session or which generally requires high reliability. Of course, as can be well understood and appreciated by the skilled person, any other suitable (low layer related) configuration may be included in this baseline configuration as well.

The baseline RRC configuration may also comprise a baseline high layer configuration (i.e., configuration for the higher layer(s), such as layer 3/L3 or even above, e.g., radio resource control (RRC) layer, non-access stratum (NAS) layer, or the like). The baseline high layer configuration may also comprise measurement-related configurations for higher layers (in contrast to L1 measurement configurations).

It may be nevertheless worthwhile to mention that such grouping or separation of the configurations for various layers is merely provided for illustrative purposes. For instance, in some possible cases, some or all of the L2 sub-layers, such as the service data adaption protocol (SDAP) layer (e.g., for SRBs), or the like, may for example be included in baseline high layer configuration (instead of low lower configuration), as can be understood and appreciated by the skilled person. In some possible cases, the baseline low layer configuration and baseline high layer configuration may be collectively referred to as a baseline (target cell/node) configuration (i.e., baseline configuration related to the target cell/node).

In addition, the baseline RRC configuration may further comprise at least one criterion (e.g., a set of various criteria) that generally governs the decision as to whether to use, initiate, or execute the proposed fast handover procedure with the respective target node (cell). As a possible illustrative example (but certainly not as a limitation of any kind), there may be a criterion indicating that a UE must not use a guaranteed bit rate (GBR) configuration that cannot be supported by the target cell (e.g., controlled by the target node, such as a gNB). Some other possible examples relating to radio (related) configurations for the UE supported or not supported by the target cell/node may include, for instance, a bandwidth configuration used by the UE, certain higher layer configuration (e.g., RLC, PDCP related configuration) for example regarding robust header compression (ROHC), or the like. In other words, if the UE is configured with a GBR (or the like as illustrated above) that cannot be supported by the target cell, the proposed fast handover procedure should not be used or initiated (by the source node) for this UE. As another possible illustrative example, a criterion to initiate the execution of the fast handover may be that the (current) load of the target cell is lower than a predetermined or predefined load criterion (e.g., a threshold, such as 50%, 30%, or the like). As can be understood and appreciated by the skilled person, such load criterion or threshold may be determined by the target cell or node itself, or by any other suitable network entity/element (e.g., operations, administration and maintenance (OAM)) of the communication system, depending on various implementations and/or requirements. The (current) load information of the target cell may be (recently) reported by the target cell/node (e.g., on request of the source node, or periodically) or estimated by the source node (e.g., based on an early report from the target cell). The load information (and correspondingly also the load criterion/threshold) may be indicated in terms of any suitable parameter, which may include (but is not limited to), the number of RRC connections maintained by the target cell/node, the number of active UEs served by the target cell/node, the number of PRBs in use in the target cell/node, the TNL capacity of the target cell/node, or the like.

In some possible implementations, the baseline RRC configuration may yet further comprise a pool or list of one or more random access preambles (sometimes may also be referred to as RACH preambles) that can be used for the fast handover procedure. The pool or list of RACH preambles may for example be predetermined, preconfigured or (pre-) reserved at the target node, such that any one of the preambles selected (by the source node) from this pool or list and assigned to the UE may be later recognizable by the target cell/node during the subsequent synchronization/random access process (for example in order to avoid collision or contention with other regular UEs). In some possible implementations, the respective pools may be updated by the source and target nodes, for instance, after some of the RACH preambles have been used/occupied, reconfigured, freed, or the like. In this sense, it may be considered that such (preconfigured or reserved) pool of RACH preambles could generally be used for the proposed fast handover procedure exclusively.

Similarly, in some possible implementations, the baseline RRC configuration may also comprise a pool or list of one or more C-RNTIs that can be used/controlled (to assign to the UE) by the source node in case of handover to a cell controlled by the target node. The pool or list of C-RNTIs may also for example be predetermined, preconfigured or (pre-) reserved at the target node, such that any one of the preambles selected (by the source node) from this pool or list and assigned to the UE may be later readily recognizable by the target cell/node during any suitable subsequent process. In some possible implementations, the respective pools may be updated by the source and target nodes, for instance, after some of the C-RNTIs have been used/occupied, reconfigured, freed, or the like. Similar to the above-illustrated pool of RACH preambles, it may also be considered that such (preconfigured or reserved) pool of C-RNTIs is generally used for the proposed fast handover procedure exclusively.

It may be worthwhile to note that, generally speaking, it may be the source network node that is in control of the determination or selection of the RACH preamble and/or C-RNTI from the respective pool, in order to avoid a possible collision issue of the RACH preamble and/or C-RNTI. However, it may still be possible that, in some examples, the target network node could be configured to determine or select (e.g., reserve) one RACH preamble and/or C-RNTI for the UE.

In some possible implementations, the target network node (e.g., a target gNB) may be configured/enabled to be in control of more than one cell. As a result, in some possible implementations, the target network node may be accordingly configured to generate a respective baseline RRC configuration for each individual cell controlled by the target node. As can be understood and appreciated by the skilled person, such multiple baseline RRC configurations generated by the target network node may be transmitted from the target network node to the source network node as separate suitable messages, or as a single (e.g., aggregated or the like) suitable message, depending on various implementations. On the other hand, other source network nodes in the system may receive respective different baseline RRC configurations from the associated target node. In this sense, it may be considered that the baseline RRC configuration is source target pair-specific.

Subsequently, in steps S203 and S204, the UE may be configured to perform measurement for the target cell(s) and report to the source node (similar to steps S101 and S102 as shown in FIG. 1).

Based on the measurements reported from the UE, the source node may be configured to decide, as shown in step S205, to perform a handover to a cell reported by the UE that has suitable measurement results (similar to step S103 in FIG. 1).

However, in contrast to transmitting a handover request message to the target node and receiving a corresponding acknowledgment message from the target node as exemplarily shown in steps S104 and S105 of the conventional handover procedure of FIG. 1, in the example embodiment of FIG. 2, the source node may be configured to (as exemplified in step S206) determine by itself whether the UE and/or the potential target cell(s) reported by the UE satisfy the criteria obtained from the target node in step S201. As such, the conventional message/signalling exchanges between the source node and the target node for the handover preparation may be skipped, thereby improving the latency issue and the overall handover efficiency. Put differently, it may also be considered that, in the example embodiments described in the present disclosure, it is the source node (instead of the target node in conventional techniques) that is responsible to perform the necessary admission control related processes. For instance, depending on various implementations of the criteria as illustrated above in detail, the source node may, in some possible examples, be configured to check whether the UE uses a GBR configuration (or other suitable radio configuration of the UE) that cannot be supported by the target cell, whether the current load of the target node is below the (predetermined) criterion/threshold (e.g., 50%), or the like.

When it is determined that the criteria for initiating/executing the fast handover are all met, the source node may be configured to, in step S208, send the handover command message with the necessary UE related configuration to the UE. The UE related configuration may comprise (part or all of) the baseline fast handover configuration as obtained from the target network node in step S201. Depending on various implementations, the UE related configuration may also comprise the C-RNTI determined/selected by the source network node (e.g., from the respective C-RNTI pool that has been received from the target network node). Similarly, the UE related configuration may also comprise the random access preamble determined/selected by the source network node (e.g., from the respective random access preamble pool that has been received from the target network node). The C-RNTI pool and/or the random access preamble pool may be source and target cell pair specific and may be reserved to be used by the source node only during the fast handover procedure to the target cell. As noted above, the C-RNTI pool and/or the random access preamble pool may be controlled by the source network node, such that possible C-RNTI and/or preamble collision issues could be avoided. As can be understood and appreciated by the skilled person, the UE related configuration may further comprise any other suitable configuration/information necessary for the UE to be successfully handed over and connected to the target cell/node. For instance, in some possible examples, the UE related configuration may comprise the user plane configuration (e.g., DRBs and SDAP, PDCP, RLC configuration, or the like). In some additional possible examples, the UE related configuration may also comprise a new key to be used by the target node for security related procedure(s). In some possible implementations, the UE may be configured to derive the new key from the current key and the target cell identifier (ID).

As exemplarily shown in step S207, the source network node may be configured to also send the UE related configuration to the target cell/node as well. Depending on various implementations, the UE related configuration sent to the target cell/node may comprise information similar to or the same as that sent to the UE (as illustrated above with reference to step S208). Notably, this step may be considered particularly necessary, specifically in cases where the source network node has determined/selected by itself a C-RNTI and/or a random access preamble out from the respective pool. In such cases, it would appear to be necessary for the target cell/node to be notified which one C-RNTI and/or random access preamble has been selected from the respective pool. In addition, in some possible implementations, the target cell/node should also be notified about the user plane configuration (e.g., DRB related configuration) of the UE at the source node. All these may be prepared/generated by the source network node and transmitted to the target cell in a suitable (existing or newly introduced) message (or as separate messages). It may be worthwhile to mention that, as can also be understood and appreciated by the skilled person, such configuration determined/selected/configured by the source network node (e.g., C-RNTI, DRB configuration) may be reconfigured by the target network node later (e.g., after the handover procedure is successfully finished), if needs be.

It is to be noted that, according to the example embodiments of the present disclosure, the dependency on target cell configuration preparation in convention techniques could be eliminated, such that the handover execution towards the UE (i.e., the handover command message as exemplified in step S208) and handover information notification towards the target node (i.e., in step S207) may be performed in any sequence or in parallel, thereby achieving considerable saving in latency/delay.

Upon receipt of the handover command message as sent in step S208, the UE may be configured to, similar to conventional techniques as shown in steps S107-S109 of FIG. 1, perform the necessary UL/DL synchronization/random access procedure in order to be successfully connected to the target cell controlled by the target network node (steps S209-S211). As a result, generally speaking, no (major/substantial) change would be necessary at the UE end, so that also legacy UEs could be used to benefit from the fast handover procedure proposed by the present disclosure. Notably, since, as illustrated above, messages towards the target cell and the UE as shown in steps S207 and S208 respectively may be sent in any sequence or in parallel, it is possible that, in some cases, step S209 may take place before step S207 (or before the complete configuration information received in step S207 is fully updated at the target cell side). In such cases, the target cell/node may be configured to be able to identify that a UE is undergoing the fast handover procedure, for example based on a fast handover specific identifier which can be the preamble allocated from the pool of (preconfigured/reserved) fast handover preambles and/or the C-RNTI allocated from the (preconfigured/reserved) fast handover C-RNTI pool. As such, the target cell/node may be configured to wait for the complete reception or processing of the message of step S207 before sending the confirmation or acknowledgment to the message sent from the UE in step S209.

Finally, in some possible implementations, the target node may be configured to, as exemplified in step S212, inform (e.g., by the transmission of a handover success message or the like with necessary indication information comprised therein) the source node about the successful handover and connection of the UE. In addition, the target node may be configured to also inform the source network node that the resources (e.g., RACH preamble and/or C-RNTI) allocated to the UE could be now freed (e.g., returned to the respective pool) so that they could be re-used or reassigned for other UEs. For instance, in some possible (non-limiting) examples, the RACH preamble could in theory be freed after the random access process is successful. In some further possible (non-limiting) examples, after the handed over procedure is complete, some of the UE related configurations (such as C-RNTI, DRB, etc.) may be reconfigured by the target cell/node depending on various circumstances, so that those configurations may also be freed (e.g., on receipt of the respective notification from the target node).

To summarize the above, as noted above, although the conditional handover procedure may generally be used to perform a (relatively) fast handover execution (compared to continental techniques) in some possible cases, it comes with disadvantages, e.g., in terms of resource reservation. Furthermore, each time the UE configuration changes, the CHO configuration may have to be re-prepared, and consequently, the UE may have to be signaled again with the correct/updated configuration. Also, in some possible cases, the UE may need to execute the handover while CHO information is being updated, which could lead to failures. In contrast, it is respectfully noted that the mechanisms/techniques as proposed in the present disclosure generally avoid unnecessary resource reservation and/or signaling overhead, thereby considerably improving the latency issue of the conventional techniques. To be more specific, the target node may be configured to prepare a respective default (baseline) target configuration for each of its cells and share this default configuration and the associated criteria to use the default configuration (e.g., UE should not have a GBR DRB configuration that the target cannot support, or the like) with neighbouring nodes. In a broad sense, it may be considered that the baseline/default configuration should be so prepared that it generally only contains the (minimum) set of (critical) configurations (e.g., certain cell-specific configurations) that a UE would necessarily need to be successfully handed over and connected to the target cell/node. Then, when the source node has a UE satisfying the associated criteria corresponding to the default target configuration, a fast enhanced handover procedure may be initiated (without the conventional handover preparation phase between the source node and the target node). As illustrated above, the criteria may be for example that the target cell/node load is less than a given threshold. The target cell configuration may also comprise information related to resources (e.g., preamble, C-RNTI, or the like) from a (predetermined or reserved) small, fixed pool. For example, each node (e.g., a NG-RAN node) may be configured to reserve one (or more) preamble in a cell towards a neighbour node and to provide this information together with the default target cell configuration. Whenever a source node is preparing a handover to the given target node in question, it can use the reserved preamble to configure CFRA HO for the UE. Similar considerations also apply to the C-RNTI pool. Generally speaking, it may be considered that the baseline configuration may comprise at least necessary cell-specific configurations (e.g., the above-illustrated low layer and high layer configuration) that are generally independent of UE (i.e., non-UE specific). In addition, and if necessary, the baseline configuration may also comprise certain UE-specific configurations that are generally (pre-) prepared/configured as a respective pool or list (e.g., the above-illustrated random access preambles, C-RNTIs, etc.). Moreover, as noted above, since the dependency on target cell configuration preparation is eliminated during the proposed fast handover procedure, the handover execution (towards the UE) and the handover information notification (towards the target node) could be performed in any sequence or in parallel, which would result in considerable saving in latency. Thereby, efficiency and flexibility of the handover procedure, and in turn, of the overall communication system could be significantly improved.

Finally, it is nevertheless to be noted that, although in the above-illustrated example embodiments (with reference to the figures), the messages communicated/exchanged between the network components/elements may appear to have specific/explicit names and/or contents comprised therein, depending on various implementations (e.g., the underlining technologies), these messages may have different names, contents and/or be communicated/exchanged in different forms/formats, as can be understood and appreciated by the skilled person.

According to some example embodiments, there are also provided corresponding methods suitable to be carried out by the apparatuses (network elements/components) as described above, such as the UE, the source and/or target network nodes (e.g., gNB, or the like.).

It should also be noted that the apparatus (or system) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the source network node, the target network node, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

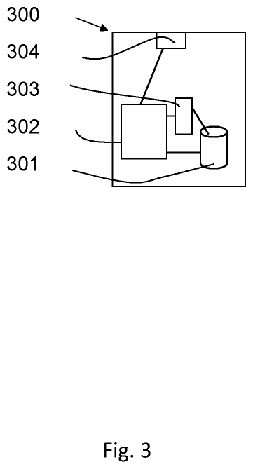

An illustrative (non-limiting) example for such an apparatus 300 is schematically shown in FIG. 3. The apparatus 300 may be configured to implement a source network node (cell) or a target network node (cell) as proposed in the present disclosure. In some possible cases, the apparatus 300 may also be implemented as any suitable network node/component/element for a communication system, for example to be coupled to and/or for controlling a station of an access system, such as a RAN node, e.g. a base station, eNB or gNB, a relay node or a core network node such as an MME or S-GW or P-GW, or a core network function such as AMF/SMF, a server or host, or in some possible implementations, a UE. Depending on various implementations, the method as described in the present disclosure may be implemented in a single apparatus or across more than one apparatus. The apparatus may be integrated with or external to a node or module of a core network, RAN, or the like. In particular, the apparatus 300 may be arranged to provide control on communications in the service area of the system. The apparatus 300 may comprise at least one memory 301, at least one data processing unit (or circuitry) 302, 302 and an input/output interface 304. Via the interface 304 the apparatus 300 may be coupled to any other suitable component (e.g., a receiver and/or a transmitter) of the apparatus 300, or to any other suitable other apparatus(es). In some possible examples, the receiver and/or the transmitter may be implemented as a radio front end or a remote radio head.

Yet in some other example embodiments, there is provided a respective apparatus (e.g., implementing the source network node, the target network node, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

1. A source network node configured for supporting an inter-node handover procedure involving at least one target network node and a user equipment, UE, served by the source network node, the source network node comprising:
at least one processor; and
at least one memory storing instructions that, when executed by the at least one processor, cause the source network node at least to:
obtain, from the target network node, a baseline radio resource control, RRC, configuration comprising configuration information usable by the UE to be handed over and connected to the target network node and information indicative of at least one criterion for executing the inter-node handover procedure;
determine whether to execute the inter-node handover procedure based on the at least one criterion; and
based on determining that the at least one criterion is met:
generate a handover command message based on the baseline RRC configuration; and
transmit, to the UE, the handover command message for enabling the UE to be handed over and connected to the target network node.

2. The source network node according to claim 1, wherein the information indicative of at least one criterion comprises information indicative of a load criterion of the target network node; and
wherein the source network node is caused to:
obtain load information of the target network node; and
determine whether to execute the inter-node handover procedure based on whether a load of the target network node indicated by the load information meets the load criterion.

3. The source network node according to claim 2, wherein the load information comprises information, with respect to the target network node, indicative of at least one of: a number of RRC connections, a number of active UEs, a number of physical resource blocks, PRBs, in use, or a transport network load, TNL, capacity.

4. The source network node according to any one of the preceding claims, wherein the information indicative of at least one criterion comprises information indicative of a radio configuration supported or not supported by the target network node.

5. The source network node according to any one of the preceding claims, wherein the baseline RRC configuration comprises a baseline low layer configuration for layer 1 and/or layer 2 and a baseline high layer configuration for layer 3 and/or above with respect to the target network node that are usable by the UE in order to connect to the target network node; and
wherein the source network node is caused to generate the handover command message to include the baseline low layer configuration and the baseline high layer configuration.

6. The source network node according to any one of the preceding claims, wherein the baseline RRC configuration comprises at least one of: a pool of at least one random access preamble or a pool of at least one cell radio network temporary identifier, C-RNTI, that are usable for the inter-node handover procedure in order to connect to the target network node and for identifying the UE by the target network node; and
wherein the source network node being caused to generate the handover command message comprises:
determining a random access preamble and/or a C-RNTI for the UE from the respective pool; and
generating the handover command message to include the determined random access preamble and/or C-RNTI.

7. The source network node according to claim 6, wherein the source network node is further caused to:
transmit, to the target network node, a first message comprising information indicative of the determined random access preamble and/or C-RNTI.

8. The source network node according to claim 7, wherein the first message further comprises information indicative of a user plane configuration of the UE at the source network node.

9. The source network node according to claim 7 or 8, wherein the source network node is further caused to:
receive, after transmitting the first message and from the target network node, a second message comprising information indicating that the determined random access preamble and/or C-RNTI is free to be reused for other UE.

10. The source network node according to any one of the preceding claims, wherein the source network node is a next generation radio access network, NG-RAN node, such as a gNB.

11. A target network node configured for supporting an inter-node handover procedure involving a source network node and a user equipment, UE, served by the source network node, the target network node comprising:
at least one processor; and
at least one memory storing instructions that, when executed by the at least one processor, cause the target network node at least to:
generate a baseline radio resource control, RRC, configuration comprising configuration information usable by the UE to be handed over from the source network node to the target network node and information indicative of at least one criterion for executing the inter-node handover procedure; and
transmit the baseline RRC configuration to the source network node.

12. The target network node according to claim 11, wherein the information indicative of at least one criterion comprises information indicative of a load criterion of the target network node; and
wherein the information indicative of the load criterion includes at least one of: a number of RRC connections, a number of active UEs, a number of physical resource blocks, PRBs, in use, or a transport network load, TNL, capacity.

13. The target network node according to claim 11 or 12, wherein the information indicative of at least one criterion comprises information indicative of a radio configuration supported or not supported by the target network node.

14. The target network node according to any one of claims 11 to 13, wherein the baseline RRC configuration comprises a baseline low layer configuration for layer 1 and/or layer 2 and a baseline high layer configuration for layer 3 and/or above with respect to the target network node that are usable by the UE for connecting to the target network node.

15. The target network node according to any one of claims 11 to 14, wherein the baseline RRC configuration comprises at least one of: a pool of at least one random access preamble or a pool of at least one cell radio network temporary identifier, C-RNTI, that are usable for the inter-node handover procedure in order to connect to the target network node and for identifying the UE by the target network node.

16. The target network node according to claim 15, wherein the pool of random access preamble and/or the pool of C-RNTI is preconfigured or reserved at the target network node for the inter-node handover procedure.

17. The target network node according to claim 15 or 16, wherein the target network node is further caused to:
receive, from the source network node, a first message comprising information indicative of a random access preamble and/or a C-RNTI determined by the source network node from the respective pool.

18. The target network node according to claim 17, wherein the first message further comprises information indicative of a user plane configuration of the UE at the source network node.

19. The target network node according to claim 17 or 18, wherein the target network node is further caused to:
transmit, after receiving the first message and to the source network node, a second message comprising information indicating that the random access preamble and/or C-RNTI determined by the source network node is free to be reused for other UE.

20. The target network node according to any one of claims 11 to 19, wherein the target network node is a next generation radio access network, NG-RAN node, such as a gNB.

21. A method of a source network node for supporting an inter-node handover procedure involving at least one target network node and a user equipment, UE, served by the source network node, the method comprising:
obtaining, from the target network node, a baseline radio resource control, RRC, configuration comprising configuration information usable by the UE to be handed over and connected to the target network node and information indicative of at least one criterion for executing the inter-node handover procedure;
determining whether to execute the inter-node handover procedure based on the at least one criterion; and
based on determining that the at least one criterion is met:
generating a handover command message based on the baseline RRC configuration; and
transmitting, to the UE, the handover command message for enabling the UE to be handed over and connected to the target network node.

22. A method of a target network node for supporting an inter-node handover procedure involving a source network node and a user equipment, UE, served by the source network node, the method comprising:
generating a baseline radio resource control, RRC, configuration comprising configuration information usable by the UE to be handed over from the source network node to the target network node and information indicative of at least one criterion for executing the inter-node handover procedure; and
transmitting the baseline RRC configuration to the source network node.

23. A communication system for supporting an inter-node handover procedure, the communication system comprising:
the source network node according to any one of claims 1 to 10;
at least one target network according to any one of claims 11 to 20; and
a user equipment, UE, served by the source network node.

24. A computer program comprising instructions for causing an apparatus to perform the method according to claim 21 or 22.

25. A memory storing computer readable instructions for causing an apparatus to perform the method according to claim 21 or 22.
